(19) United States
(12) Patent Application Publication
(10) Pub. No.: US 2015/0286726 A1
(43) Pub. Date: Oct. 8, 2015

(54) Methods, Apparatuses, And Systems For Facilitating Access To, And Organization Of, News And Other Information Relating To One Or More Entities Or Subjects

(71) Applicant: NewsOther, Inc., Scarsdale, NY (US)

(72) Inventor: Andrew H. Rush, Scarsdale, NY (US)

(21) Appl. No.: 14/677,030

(22) Filed: Apr. 2, 2015

Related U.S. Application Data
(60) Provisional application No. 61/974,313, filed on Apr. 2, 2014.
(60) Provisional application No. 61/976,376, filed on Apr. 7, 2014.
(60) Provisional application No. 62/090,238, filed on Dec. 10, 2014.

(51) Int. Cl. G06F 17/30; G06F 3/0484; H04L 29/08; G06F 3/0482

(52) U.S. Cl. CPC G06F 17/30864; G06F 3/0482; G06F 3/04842; H04L 67/306

(57) ABSTRACT

Methods and apparatuses described herein can conduct and organize web searches and/or news searches based on profiles and topics lists for entities (e.g., a person, business, or organization) or subjects. Entity profiles may include biographical information (e.g., name, employer, school, location) to enhance accuracy of web searches and news searches. A topics list may be created and associated with any entity/subject profile, and news searches may be conducted based on topics included in the topics list for any profile. Results from web or news searches may be saved in or otherwise linked to the entity/subject profile. Profiles may be created for multiple entities and subjects, and each profile may have numerous topics associated with such profile. Such profiles and topics lists may be edited and/or recalled to facilitate launching of web or news searches to gather news and/or other information relating to the selected entity, subject or topic.

### CROSS-REFERENCES TO RELATED APPLICATIONS

This application claims priority to and the benefit of U.S. Provisional Patent Application Ser. No. 61/974,313, filed Apr. 2, 2014, and titled “METHODS, APPARATUSES, AND SYSTEMS FOR FACILITATING ACCESS TO NEWS AND OTHER INFORMATION RELATING TO AN ENTITY”; U.S. Provisional Patent Application Ser. No. 61/976,376, filed Apr. 7, 2014, and titled “METHODS, APPARATUSES, AND SYSTEMS FOR FACILITATING ACCESS TO, AND ORGANIZATION OF, NEWS AND OTHER INFORMATION RELATING TO AN ENTITY”; and U.S. Provisional Patent Application Ser. No. 62/090,238, filed Dec. 10, 2014, and titled “METHODS, APPARATUSES, AND SYSTEMS FOR FACILITATING ACCESS TO, AND ORGANIZATION OF, NEWS AND OTHER INFORMATION RELATING TO ONE OR MORE ENTITIES OR SUBJECTS.” The entire contents of the aforementioned applications are hereby expressly incorporated by reference in their entirety.

### BACKGROUND

A common approach for obtaining information about a particular subject, or an entity of interest (e.g., a person, a business, a location, an organization, or an institution), involves manual web browsing/searching via available search engines, websites, and/or other information sources to aggregate a knowledge set about the entity or subject. This type of effort to gather news and information about a subject or entity of interest conventionally tends to be disjointed, incomplete, disorganized, and time-consuming. Moreover, conventionally available techniques do not readily provide for useful aggregation and organization of news and other information about numerous subjects or entities, particularly if multiple different types or categories of information topics of inquiry (“topics”) are associated with one or more of the subjects or entities of interest.

For example, some currently available methodologies allow a user to specify “custom” news topics, which the user can add to a list of news topics generally preconfigured by the methodology. These methodologies therefore allow a user to select custom news topics to follow. However, this method can become cumbersome if the user has more than a few custom topics which he or she wishes to follow.

### SUMMARY

In view of the foregoing, various inventive embodiments disclosed herein are directed to methods, apparatuses, and systems for facilitating access to news and other information relating to an entity or subject of interest and organizing such news and other information. The inventive embodiments disclosed herein enable users to access news and other information relating to specified topics for each such entity or subject and to organize such news and other information in an easily usable manner. The ultimate benefit of such inventive embodiments is that news and information on numerous topics for each of numerous subjects or entities can be accessed and easily organized. The various inventive embodiments disclosed herein allow a user to organize the news and/or custom topics using two levels of organization (e.g., profiles and topics). A user can create profiles for numerous entities or subjects. Then for each profile a user can enter numerous topics to follow. Using this means of organization, the user can access and organize news and information relating to numerous topics, each of which are associated with different entities or subjects.

More specifically, the inventive concepts disclosed herein facilitate the aggregation and organization of news and/or other information around a particular entity or subject by allowing users to create profiles and topic lists centered around particular entities or subjects. Thus, the inventive embodiments disclosed herein enable a user to follow and track numerous news topics for each of numerous entities or subjects. This manner of aggregation and organization greatly expands the number of news items and the amount of news which a user can practically track and follow.

In example implementations, a user can input subjects and names of entities, and topics associated with each, in order to aggregate and organize news relating to such subjects and entities and the topics associated with each. In some implementations, a user may be able to automatically generate and organize web searches and/or news searches based on information inputted by the user, including an entity or subject name, various other biographical information about an entity, a list of interests and/or affiliations related to the entity, and/or other details relating to the entity. In some implementations, if the user does not have a list of interests and/or affiliations related to an entity, such information may be obtained at least in part from one or more social media profiles for the entity in order to generate and organize such a list of interests and/or affiliations. Generally speaking, the quantity and/or diversity of base information on which queries are predicated according to various embodiments provide for deeper or fuller searches to be performed with enhanced results.

For purposes of the present disclosure, “news” about an entity or subject (as distinguished from other types of information relating to the entity or subject) generally pertains to relatively recent events and/or developments relating to the entity or subject, and may include various information obtained from a conventional news source. Examples of conventional news sources include, but are not limited to, a newspaper, a blog, a radio and/or podcast, a social network website, and/or news aggregation website (e.g., Google News, RSS feeds, Yahoo! News, and Bing News).

The ability to easily gather and organize news and/or other varied information about an entity or subject of interest has significant applicability to many aspects of social and/or professional engagement (e.g., managing companies or investments, preparing for interviews, conversations, meetings, strategy sessions, sales calls, dates, parties, etc.). More specifically, the ability to create and organize entity-centric or subject-centric profiles including base information and a list of topics of interest or relevance to the entity or subject, on which news searches relating to the entity or subject may be predicated, provides for a rich results base of valuable information that is particularly useful in many social and/or professional environments.

For example, a job candidate preparing for interviews may want to create profile pages for the businesses or industries in which the candidate is interviewing. In particular, a job candidate interviewing for a job in the investment banking industry might want to create a profile for the subject titled “Investment Banking” As topics for this profile the job candidate could list the name of each investment bank and also any laws or regulatory agencies impacting the investment banking industry. Prior to an interview the job candidate could review the news relating to the investment bank with which the job candidate is interviewing, the news relating to competitive investment banks and the news relating to developments relating to such laws or regulatory agencies.

In another example, a person interested in the 2016 presidential elections could create a profile for the subject “2016 Elections.’ As topics for this profile the user could enter the names of the leading presidential candidates or prospects. By pressing on any particular topic, the user could access and review the news pertaining to that particular candidate or prospect. Furthermore, the user could elect to save any article of interest and the saved article would be retained on the “saved” page for the 2016 Election profile. Using this methodology, saved articles can easily be located and referenced.

In another example, an employer may make a profile for a job candidate for whom the employer has a resume by supplying the job candidate's name, address, and the businesses and/or organizations she has done work for. The employer may also include in the profile any interests and/or activities included on the resume, in order to gather news and/or other information related to the candidate's interests or activities. The employer may then use the job candidate's profile to keep updated on news related to the job candidate (e.g. so that the employer can see current information regarding the job candidate's contributions, work, scandals, and/or other related information), the businesses and/or organizations the job candidate has worked for (e.g., so that the employer has current information on the business to inform the interview and/or to inform the employer of potential reasons why a candidate may want to leave a business), and/or on topics related to the job candidate's activities and interests (e.g., to better facilitate a discussion of said activities and/or interests as they apply to a job opening).

In yet another example, a banker, consultant or salesman may create a profile and topics list for the CEO of a company. In the CEO's profile the banker, consultant or salesman enters the CEO's name, current employer, former employer, school affiliations and location of the CEO's residence. In the topics list page for the CEO the banker, consultant or salesman enters the company's industry, competitors, customers and suppliers, as well as the name of any relevant regulatory agencies or indexes which track activity in the company's industry. Also in the topics page the banker, consultant or salesman lists items of personal interest to the CEO, such as the names of politicians in the CEO's location, the CEO's favorite sports teams, entertainers and TV programs. The banker, consultant or salesman reviews the news generated on each of these topics prior to each meeting or conversation with the CEO. The banker, consultant or salesman also reviews such news before each meeting in his organization to discuss the CEO's company and competitors. The banker, consultant or salesman also reviews the news generated on these topics so that he can find news of interest to forward to the CEO.

As a further example, a parent may make a profile for one of his children which may be generated based on the child's name, location, and interests. The parent may then be able to use the profile to keep track of his child's accomplishments, to keep updated on, e.g., the child's favorite bands, films, sports teams, etc. Further examples may include creating a profile to aggregate news about oneself, one's interests, important news topics, one's relatives, friends, co-workers, clients, celebrities, employers, competitors, customers, one's home (and/or another person's home), a travel destination, a sports team, a television show or film, an education institution, and an organization (e.g. a non-profit organization, a charity).

In some implementations, the news and/or other information may be obtained from news aggregators, news websites, RSS feeds, social networking websites, and search engines via a News Aggregation Controller (“NAC”) which may use the user-provided information about an entity or subject to perform searches for data pertaining to the entity or subject or pertaining to topics associated with the profiles of entities or subjects. In example embodiments discussed in greater detail below, the various functionality disclosed herein in connection with such a News Aggregation Controller (NAC) may be implemented via various computing devices, examples of which include, but are not limited to, any of a variety of mobile computing devices (e.g., via an “app” downloaded to and executing on a “smart phone”), and/or one or more stationary computing devices (one or more “servers”).

In addition to generating new profiles for entities or subject of interest, and topics lists associated with a profile for one or more entities or subjects of interest, as well as conducting search queries based on generated profiles and aggregating/organizing information obtained via searches pursuant to such queries, the NAC may also facilitate creating connections between users and one or more entities for which profiles are generated (e.g., the NAC may indicate that the user shares a connection on LinkedIn with an entity having a profile, or that the user has a mutual Facebook friend). Users can specify information retrieval as well, e.g., whether the NAC retrieves all news and/or other information for an entity or subject associated with a profile, or whether the NAC only retrieves news related to common interests (and/or may specify whether this comparison is made for all news sources or for particular news sources, e.g., social media sources such as Facebook, Twitter, and/or the like). The NAC may also provide email alerts to the user when new news and/or other information is found and incorporated into an entity or subject profile.

The user may also create a personal profile page containing news pertaining to interests, entities, and/or other related topics which the user may wish to receive information about on a regular basis.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIGS. 1A-1C illustrate various apparatus and information flows for facilitating access to news and/or other information concerning an entity or subject, according to one embodiment of the present invention.

FIG. 2 illustrates a logic flow diagram for creating an entity or subject profile, according to one embodiment of the present invention.

FIG. 3 illustrates a logic flow diagram for creating a topic for an entity or subject profile, according to one embodiment of the present invention.

FIG. 4 illustrates a block diagram for creating an entity or subject profile, according to one embodiment of the present invention.

FIG. 5 illustrates a diagram showing how content may be viewed, according to one embodiment of the present invention.

FIG. 6 illustrates creating a profile, according to one embodiment of the present invention.

FIG. 7 illustrates creating a profile, according to one embodiment of the present invention.

FIG. 8 illustrates a topics list, according to one embodiment of the present invention.

FIG. 9 illustrates adding a topic to a profile or account, according to one embodiment of the present invention.

FIGS. 10A-C illustrate adding a topic to a profile or account, according to one embodiment of the present invention.

FIG. 11 illustrates default topics, according to one embodiment of the present invention.

FIG. 12 illustrates a news interface, according to one embodiment of the present invention.

FIG. 13 illustrates a profile list, according to one embodiment of the present invention.

FIG. 14 illustrates a settings page, according to one embodiment of the present invention.

FIG. 15 illustrates a saved articles list, according to one embodiment of the present invention.

FIG. 16 illustrates an alternative profile list, according to one embodiment of the present invention.

FIGS. 17A-C illustrate displaying news, according to one embodiment of the present invention.

FIG. 18 illustrates a block diagram showing an example of a News Aggregation Controller (NAC) according to one embodiment of the present invention.

### DETAILED DESCRIPTION

Following below are more detailed descriptions of various concepts related to, and embodiments of, inventive methods, apparatuses and systems for facilitating access to news and other information relating to an entity. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

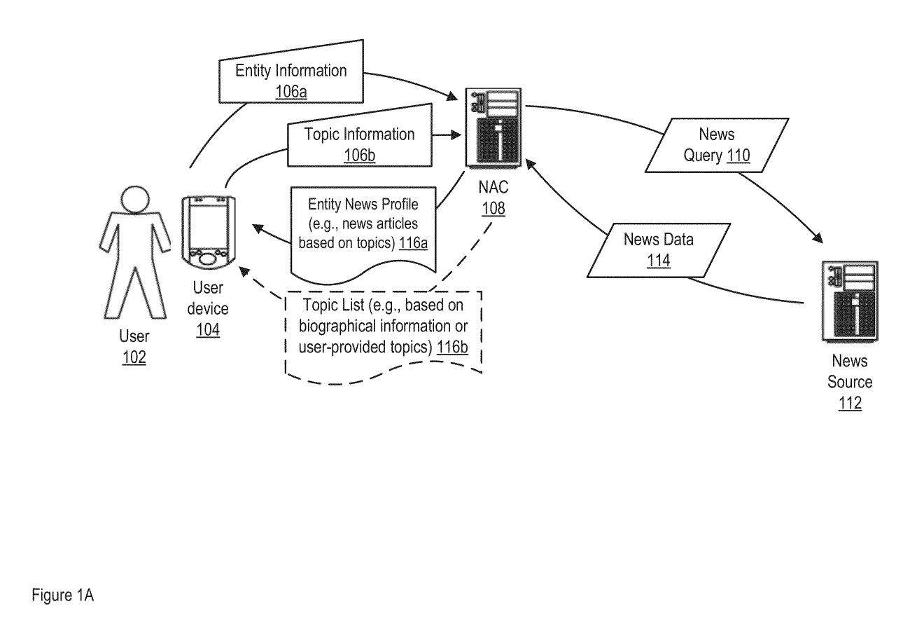

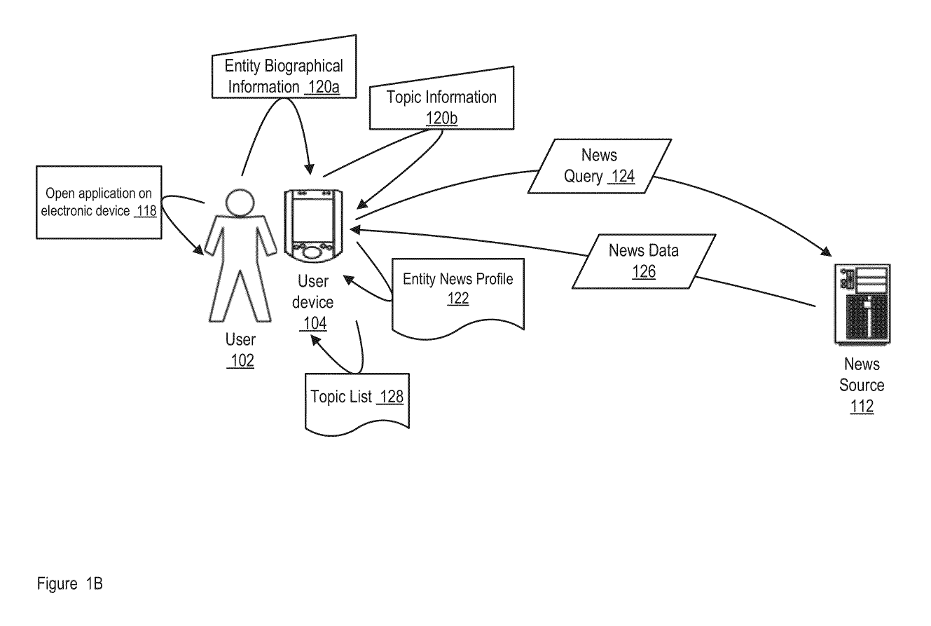

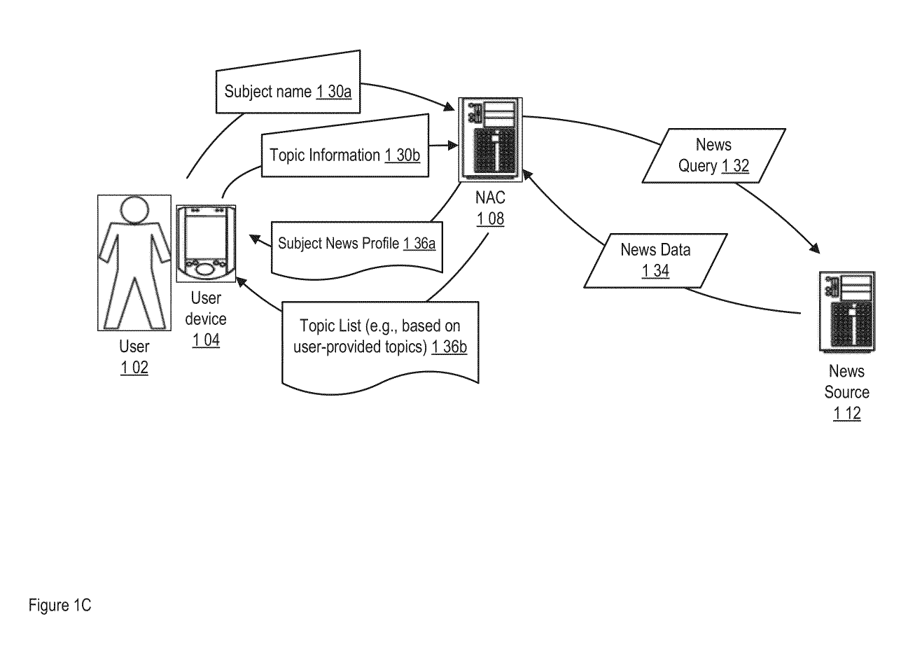

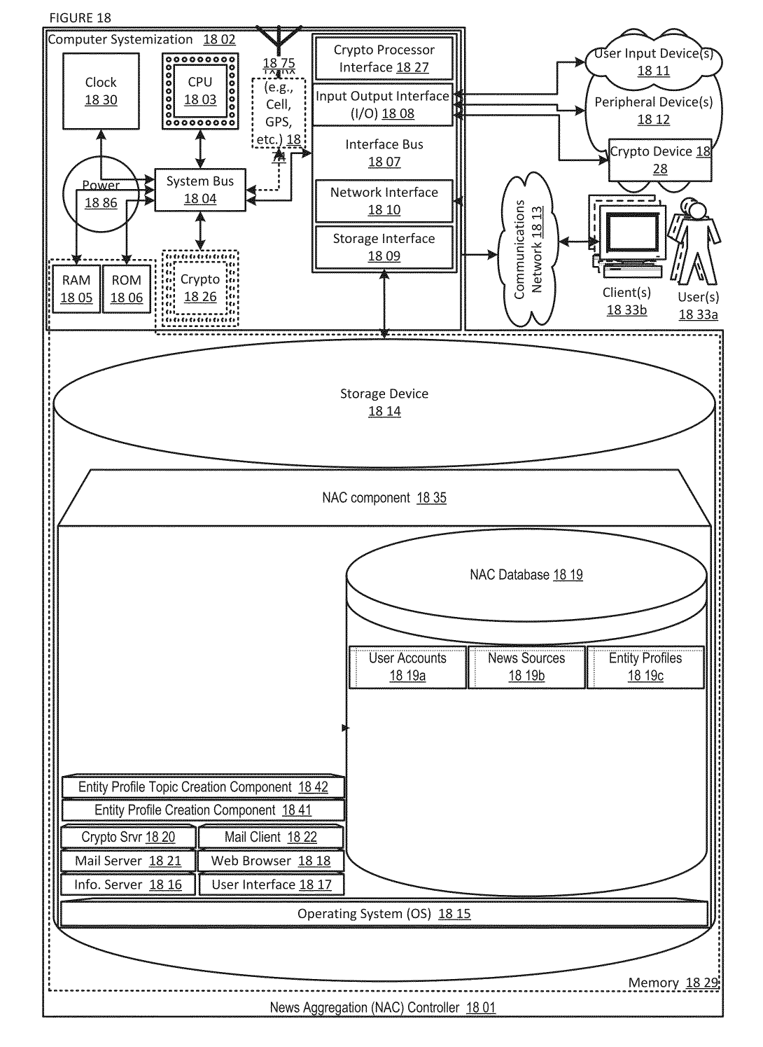

FIG. 1A illustrates apparatuses and information flows for facilitating access to news and/or other information concerning an entity, according to one embodiment of the present invention. In some implementations a user 102 may use an electronic device 104 in order to obtain said news and/or other information. The electronic device may be a mobile device (including but not limited to mobile phones, smart phones, tablets, laptops, and/or PDAs), a personal computing device, and/or any computing device utilizing processors, memory, communications interfaces, user interfaces, and/or display devices, and may be configured to interact with a server device which may utilize processors, memory, and/or communications interfaces. Further examples of the functionality of the electronic device may be found at least in FIG. 18 (e.g., at least 1802-1810, 1830, 1874-1875, and 1886).

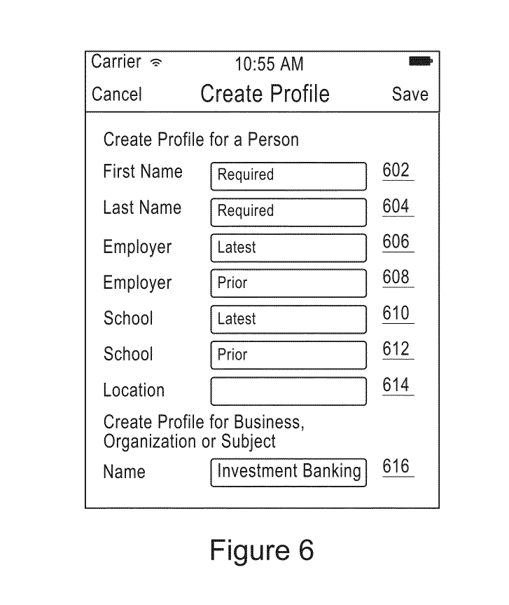

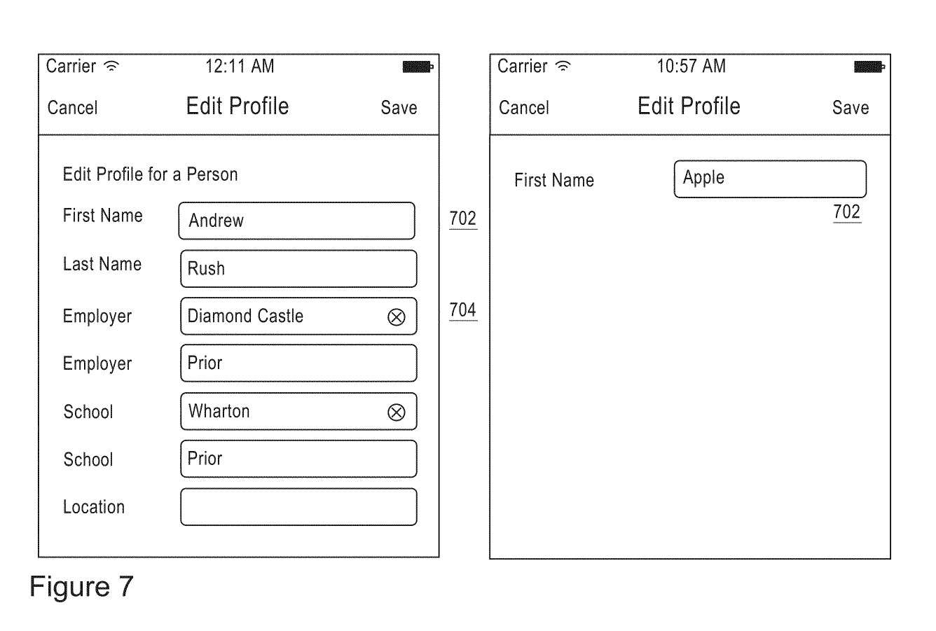

The user may be able to provide entity biographical information 106a to an NAC 108 (described in further detail via FIG. 18). In some implementations, the user may provide the entity biographical information for an individual to the NAC via an interface such as in FIG. 6. If the entity is a corporation, business, or other such entity, the entity biographical information for the entity may include the entity's name. If the entity is a person, the entity biographical information may include the entity's name (including but not limited to a first 602 and/or last 604 name of a person), location and/or address 614, and/or an employer and/or CEO (e.g., a current employer 606 or a prior employer 608), and/or a school 610 and/or alma mater 612. The user may also be able to provide topics 106b to associate with the entity, such as a favorite sports team, an employer, and/or school (e.g., if the entity is a person), and/or a second entity associated with the entity. In some implementations, as shown in FIG. 7, some fields may be required, while some may be optional. Optional fields 704 may be denoted by an icon which allows the user to quickly remove the optional information from the profile details, while required fields 702 may not have such an icon.

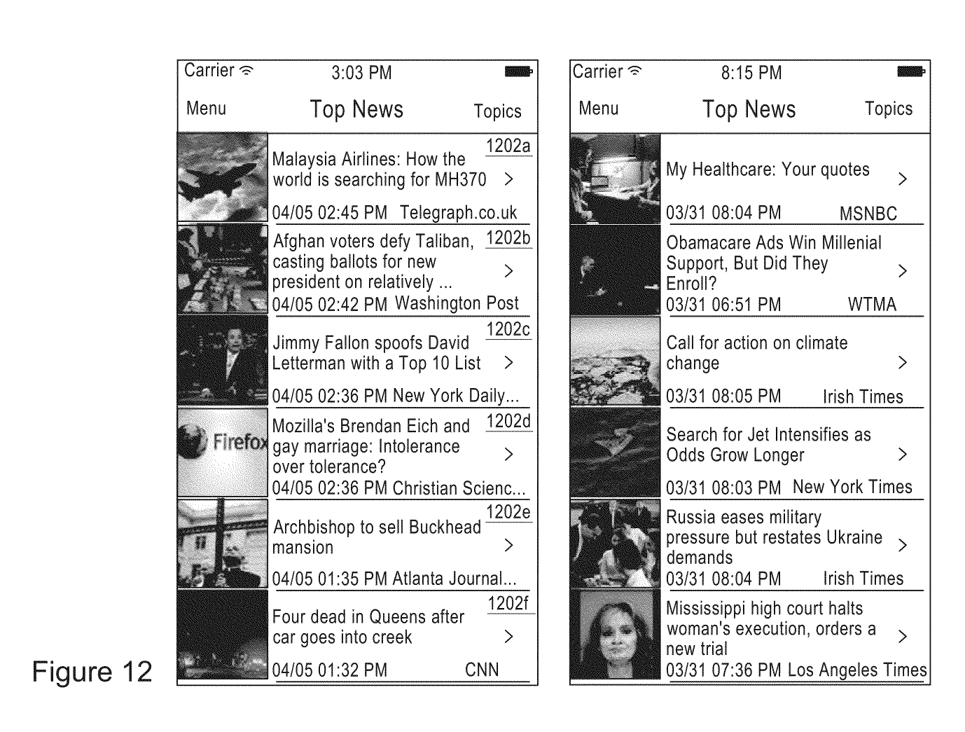

The NAC may use the entity biographical information provided by the user to generate a news query 110 to send to a news source server 112. The news source server may use the news query to query its available news database(s) for news pertaining to the entity and/or topics pertaining to the entity based on the search criteria provided. A news source may be any one of a news website, a blog, a news aggregation website, a generic search engine, and/or a similar source of important information pertaining to entities. The news source may provide any news data 114 it finds to the NAC, which may then generate a news profile data structure for the user using the user-entered entity data. The news profile data structure may include identifiers and/or links to particular news articles, and/or topics and/or keywords used to query the news source for information on the entity. The topics and/or keywords may be derived from the entity's biographical information, and/or specifically provided by the user. The NAC may send said entity news profile page 116a for the entity to the user for perusal, containing references to a plurality of news articles and/or stories associated with the entity. For example, referring to FIG. 12, in some implementations news articles may be provided to the user in a selectable list format 1202a-f which may include a photo, article title, article publication date and time (and/or a date and time the article was retrieved for the profile page), and/or the source of the article.

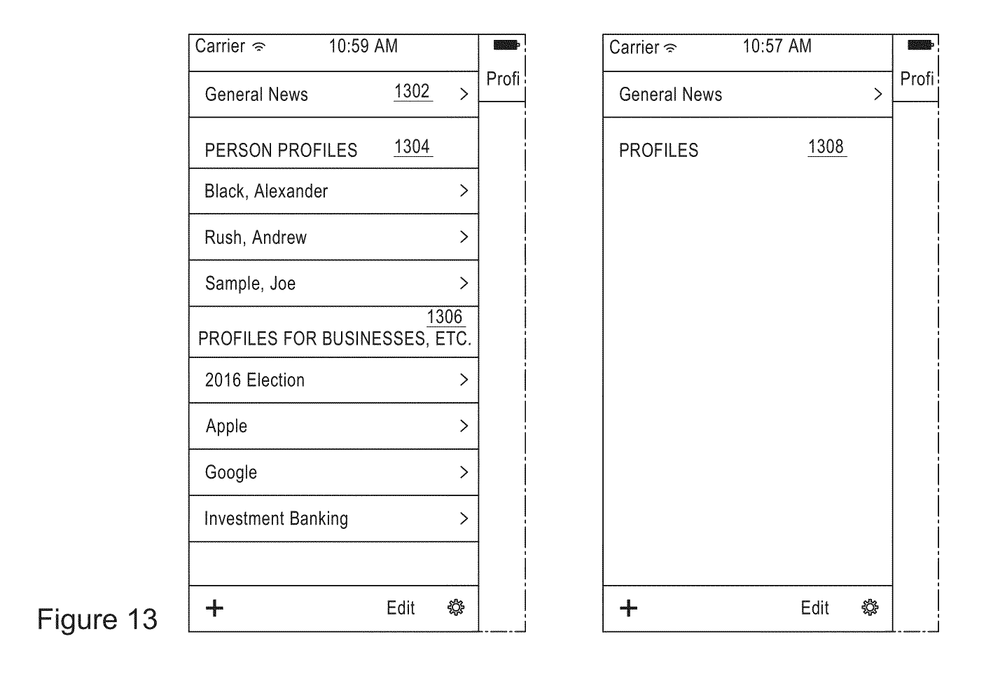

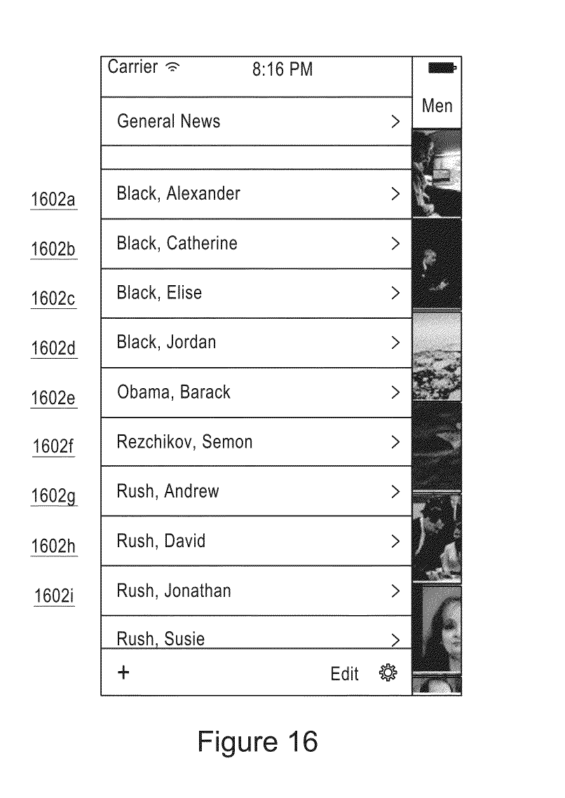

In some implementations, the entity news profile may comprise only the entity data provided by the user; in other implementations the news profile may comprise the entity data and any news found using the entity data, which may be saved to the profile as it is received, and/or as a user indicates that a particular piece of news should be saved to the profile. The NAC may also use data from social network profiles and/or pages associated with the entity to extract more biographical information to add to the profile, and/or to import news and/or other information for display on the entity news profile page. In some implementations the user may be able to view a list of all the profiles the user has created, wherein selecting an entity name in the profile list may redirect the user to the entity's profile page. Referring to FIG. 13, the profiles may be divided into multiple selectable lists based on the types of entities the profiles relate to (e.g., a first list may comprise profiles relating to people 1302, while a second list may comprise profiles relating to businesses 1304). In other implementations, profiles, regardless of the type of entity, may reside in a single unified list of profiles (e.g., see 1308 of FIGS. 13, and 1602 of FIG. 16).

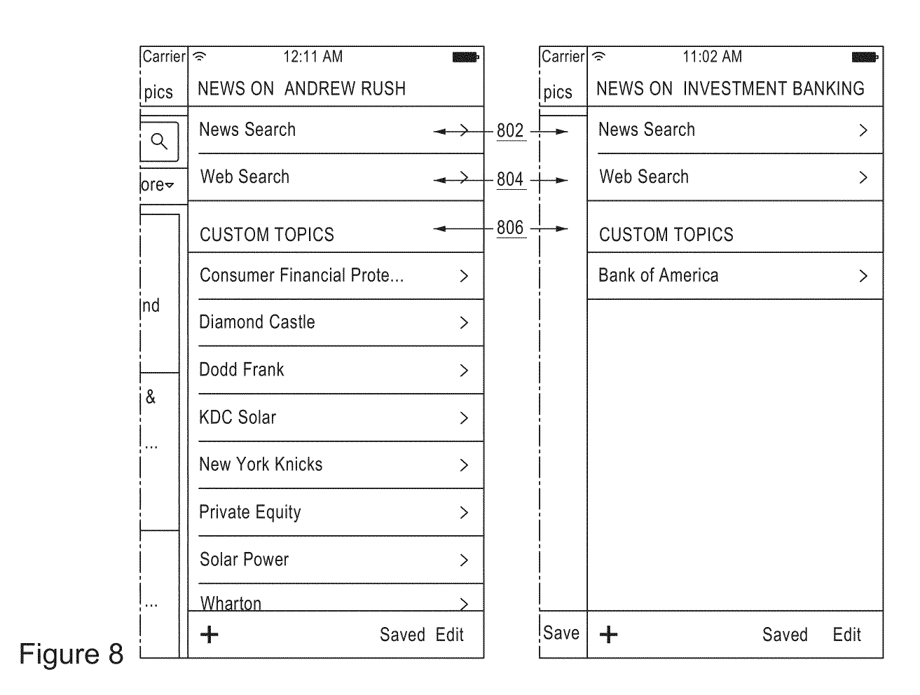

In some implementations, any user-provided topics may be used to add further content to each profile, e.g., as sub-components of the profiles, as separate pages from the profile pages, and/or the like. The topic pages may be presented to the user via a topic list 116b accessible from the entity's profile page that the user may use to select topic pages to navigate to. Topic lists can be generated by user-provided topics, and/or by the entity's biographical information. FIG. 8 illustrates an exemplary topic page comprising a selectable list of topics 806 entered by the user. In some implementations, the user may also be able to access news 802 and web searching 804 functionality while viewing the topics associated with the profile.

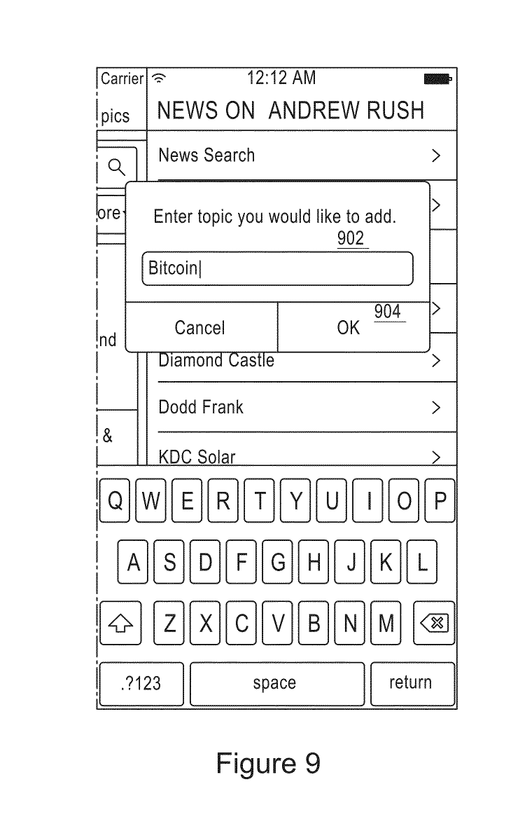

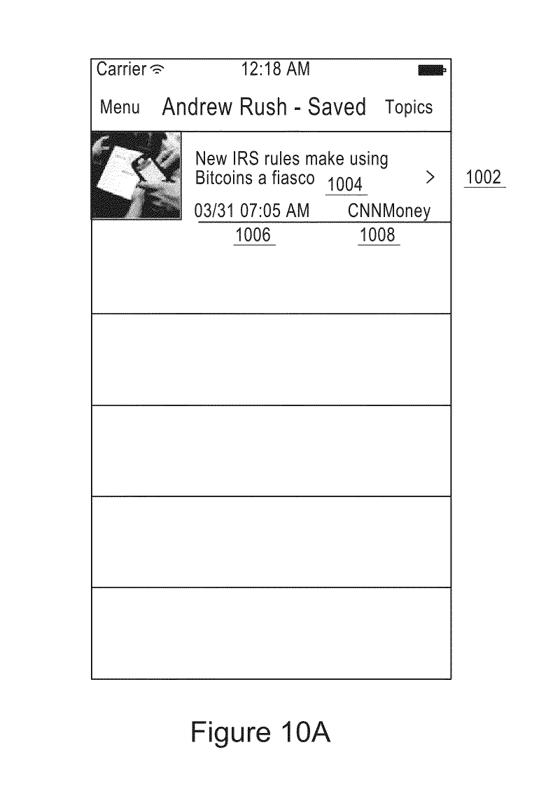

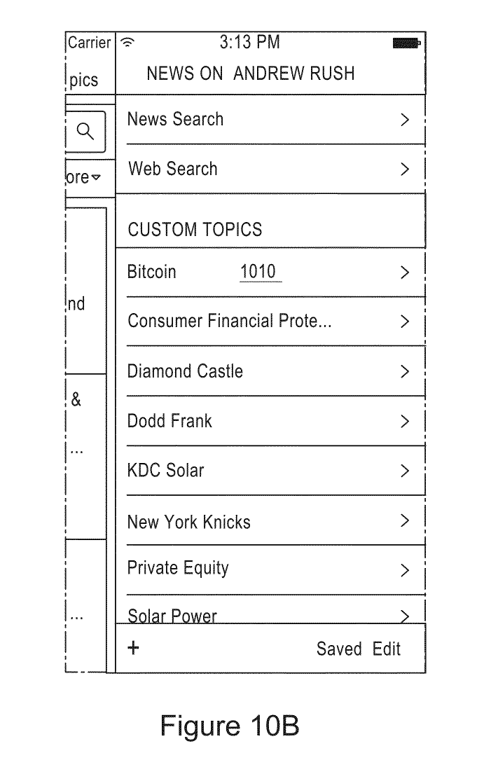

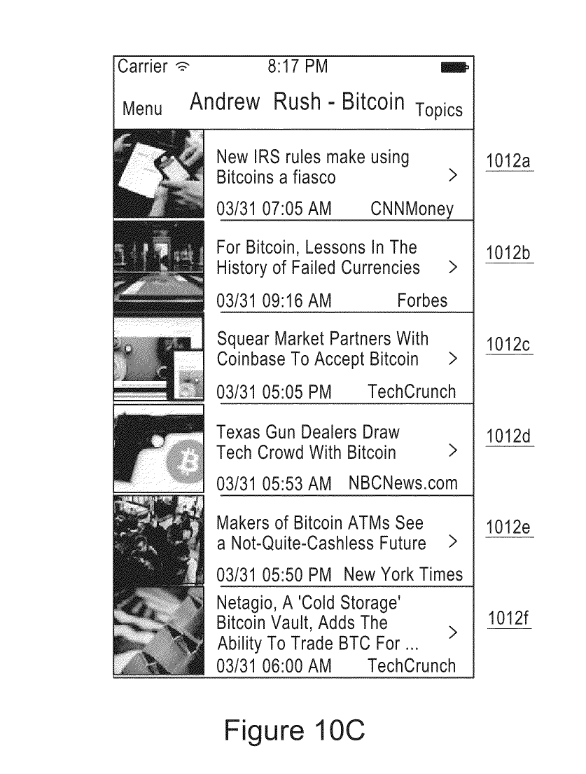

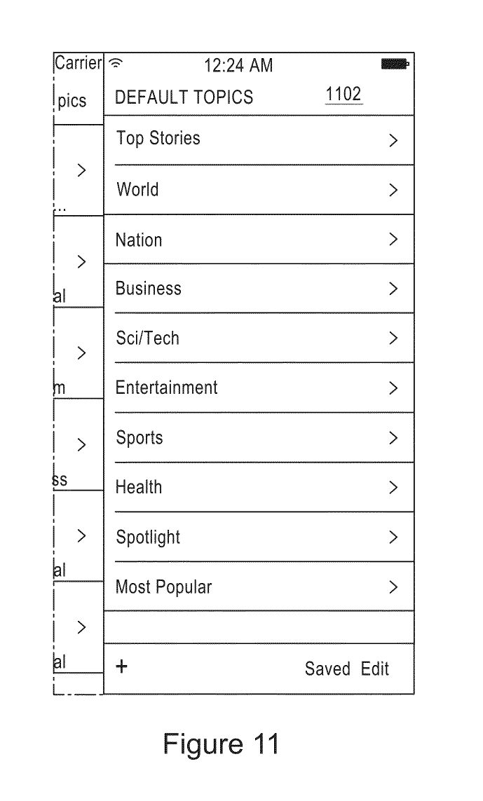

Referring to FIG. 9, in some implementations the user may be able to add a new topic by typing in a topic term and/or phrase 902 and confirming the topic term 904. Referring to FIG. 10B, the user may be able to view the new topic term in her custom topics list 1010, and, referring to FIG. 10C, may then be able to view topic content 1018a-f relating to the topic term. Referring to FIG. 10A, the user may also be able to save content 1002 related to the topic, to be displayed with other content obtained for the user's perusal. Saved content may be displayed with its title 1004, date it was published (and/or added to the saved list) 1006, and the source of the content 1008. In some implementations, topic page content may be derived from news sources similar to the process of deriving entity-specific news. In some implementations the topic page content may only come from news-only sources (e.g., for example, news websites and/or news aggregation websites, but not generic search engines). Topics may also be derived via extracting interests and/or other data from the entity's social network profile and/or page and using the extracted data to generate and populate further topic pages. In some implementations, referring to FIG. 11, the application may provide the user with a default list of topics 1102a-j, e.g., unrelated to specified topics, profiles, and/or the like, that the application may automatically provide content for. The default list of topics may be retrieved by a news source, may be generated by the NAC, and/or the like.

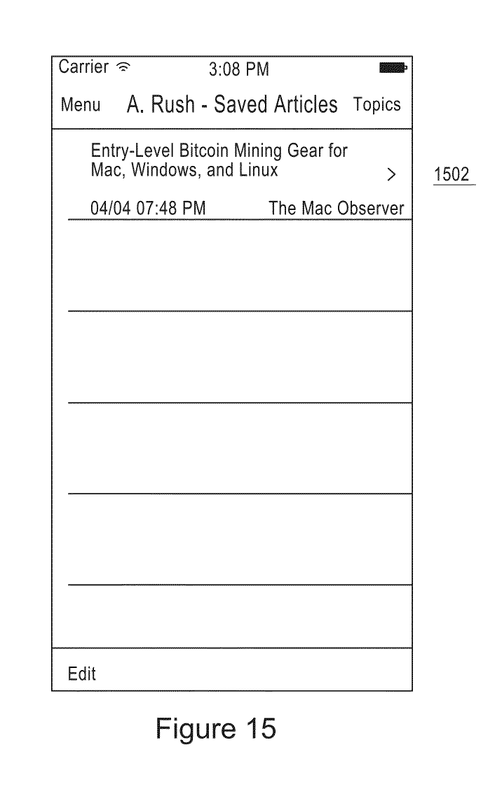

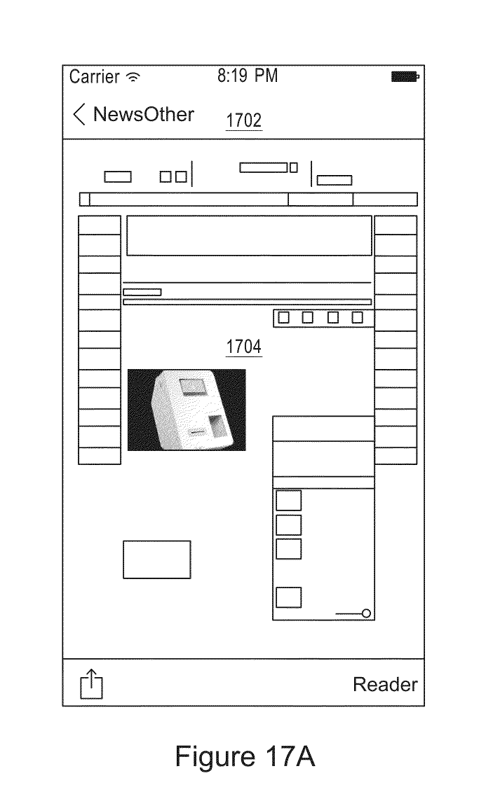

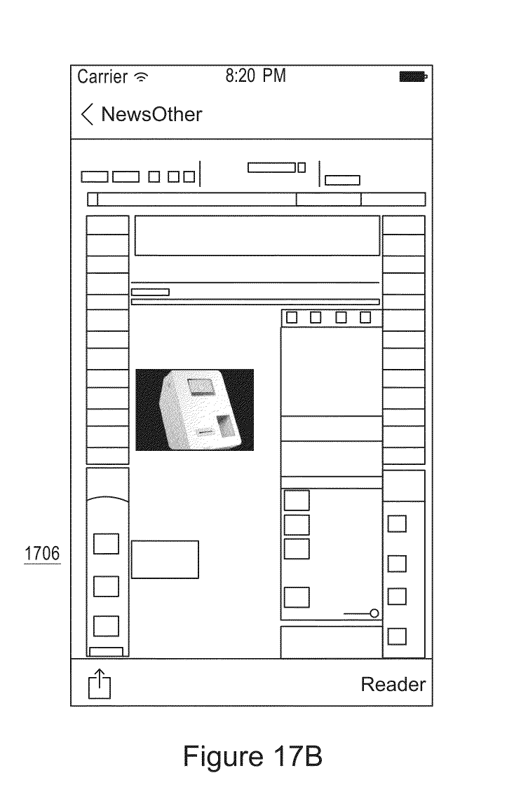

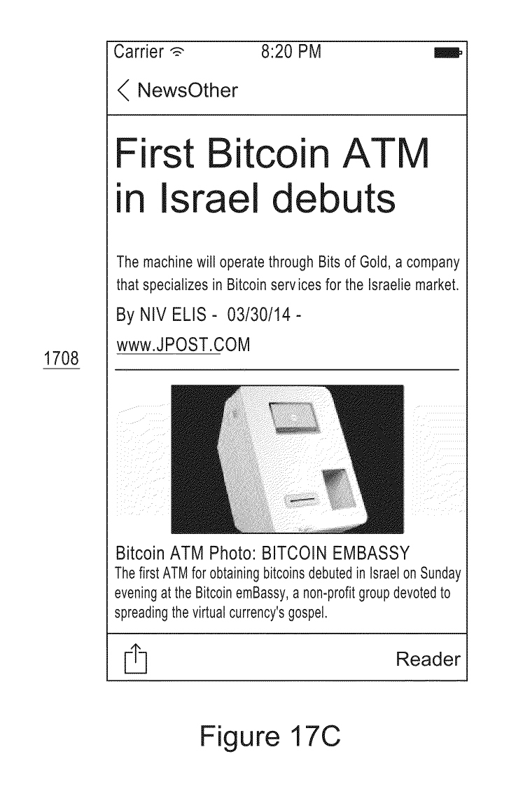

In some implementations users may be able to use the profile to view news on the entity, as shown in FIGS. 17A-C. For example, the application may facilitate a Reader page 1702 which may display a news article 1704 corresponding to the selected content in the profile. In some implementations, the application may redirect the user to the original website of the article, and/or may encapsulate the original website and the article within the application itself. In some implementations, as shown in FIG. 17C, the Reader page may be configured to obtain a mobile-friendly version 1708 of the article, and/or may reformat the article to be mobile-friendly. Referring to FIG. 17B, the Reader page may display advertisements 1706 on the article page. The advertisements may be able to be removed, e.g., if the user subscribes to a different subscription plan. In other implementations, the advertisements may only appear in the original article, and may be removed from all articles shown in the Reader. The user may also be able to share news about the entity with other people (e.g., people with or without accounts on the NAC), and to share profiles on entities (e.g., with people having accounts on the NAC). Referring to FIG. 15, in some implementations a user may also be able to save articles she reads (e.g., on the application, on another application, and/or the like) to a particular entity's profile 1502, and/or the like.

In other embodiments, with reference to FIG. 1B, some or all of the functionality described above and elsewhere herein in connection with the NAC and/or other components (e.g., the user device 104 shown in FIG. 1A) may be implemented in part or entirely in the context of a mobile computing device (e.g., a mobile phone or “smart phone”). Stated differently, all or a portion of the NAC itself as disclosed herein may be implemented in the context of a mobile computing device. To this end, in one implementation the various functionality described herein associated with one or both of the user device 104 and the NAC 108 may be accomplished via an executable application (an “app”) resident on a single mobile computing device (e.g., the user device 104 shown in FIG. 1B may be configured to implement some or all of the functionality described in connection with the user device 104 and NAC 108 shown in FIG. 1A, or described in connection with any of the other figures).

For example, rather than a user device 104 interacting with the NAC 108 as shown in FIG. 1A, the user's electronic device 104 (e.g., a mobile/smart phone) may instead generate and send queries to the various news sources itself, without the use of a separate NAC. In one such embodiment, upon opening an application 118 (e.g., downloaded from an application store, and/or otherwise instantiated on the device), instead of sending entity biographical information 120a or topic information 120b to a separate NAC 108, the user device may use the information itself to generate an entity news profile 122, and to generate and send a news query 124 to a news source. The user device may also be equipped to perform searches on topics in a similar manner (e.g., without sending the topic information 128 to the NAC). The news source may then send news data 126 directly to the user device, which may process the information and display the news elements for the user. In such implementations, the user's electronic device may store the entity news profile, topic list, and/or other information locally on the electronic device's hardware. In this implementation, an application hosted on the user device to facilitate the functionality described herein need not connect to or utilize any server other than a news source server. In other implementations, the user may also elect to have the NAC and/or a similar server serve as a cloud storage location on which the user's profiles and/or related information may be stored.

In some implementations the user may be able to generate up to a pre-determined number of profiles for free (e.g., 10), and may need to pay a subscription fee, a per-profile fee, and/or a per-package-of-profiles fee (e.g., of $0.99 per 10 profiles) in order to generate further profiles.

In other embodiments, with reference to FIG. 1C, a user may also be able to create a news profile based on a subject. For example, the user 102 can provide, via his electronic device 104, a subject name 130a to the NAC 108. The subject name can be any term and/or phrase relating to a news and/or information subject. The user can also submit topics 130b associated with the subject which can be used to retrieve related news and/or information associated with the subject. As an example, the subject can be “Technology,” where exemplary subjects can include “Microsoft,” “Apple.” “Google,” “iPhone,” and/or similar related topics.

Similar to the process in FIG. 1A, the NAC 108 may query a news source server 112 via news query 132, which may include the subject and topic data provided by the user. The news source server 112 may then provide news data 134 to the NAC 108, including news articles and/or similar information relating to the subject and to the chosen topics. The NAC 108 may then provide both a subject news profile page 136a and a topic list 136b to the user. The subject news profile page 136a may contain a list of news articles and/or other information retrieved in relation to the subject. The topic list 136b may include a list of topics that the user may select in order to view more news and/or related information relating to the subject, based on the topics chosen by the user.

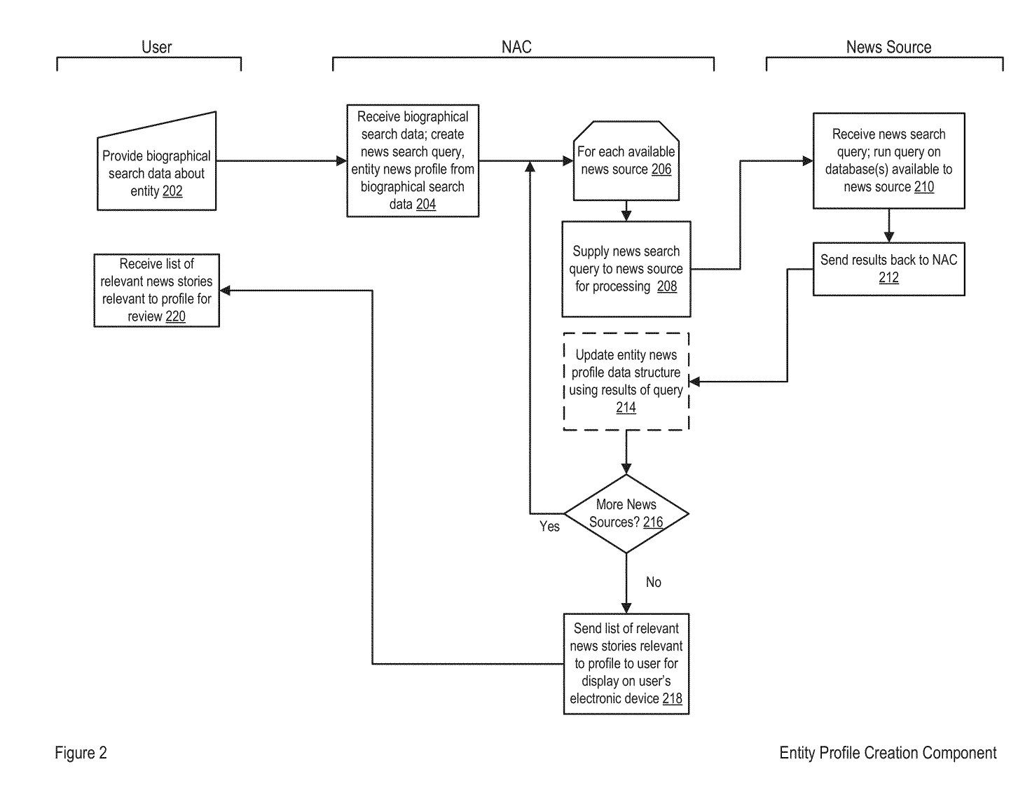

FIG. 2 illustrates a logic flow diagram illustrating creating an entity profile, according to one embodiment of the present invention. For example, the user may provide biographical search information 202 about the entity (e.g., the entity's name, location, employer and/or CEO, and/or school) to the NAC and/or to the mobile application on the user's mobile device. Once the NAC and/or mobile application on the user's mobile device receives the search data 204, it may create a news search query based on the biographical search data. In some implementations the search query may resemble a search string; e.g., if a user enters “John Smith, Harvard University,” the search query may resemble “‘John Smith’ ‘Harvard University’.” The NAC and/or mobile application on the user's mobile device may determine a set of news sources (e.g. news websites, news aggregators, search engines) it can poll for news information. The user may be able to specify from which sources (e.g., from which websites and/or from which source category) the user would like the news results to be derived from (e.g., the user may be able to choose which news aggregators to query and may choose not to include news websites, for example). In some implementations, all of the biographical information provided may be included in the search query. In other implementations, only a portion of the biographical information provided may be included. For example, only the entity name and employer and/or CEO may be used initially; if the user did not provide an employer, the entity name and school may be used for the search query; if the school was not provided, the entity name and location may be used. In such implementations, the NAC and/or mobile application on the user's mobile device may store the data not used in the search query in the profile for future reference and/or to generate subsequent queries.

If the user does not have enough information about the entity to properly identify the entity, the user may instead be able to provide a link to at least one of the entity's social networking pages (e.g. Facebook, LinkedIn, and Twitter). The NAC and/or mobile application on the user's mobile device may use the social networking pages to extract biographical data for better searches from the news sources, to extract news and/or other information from the social networking page itself, and/or to auto-generate new topic pages for the entity based on interests and/or other data derived from the social networking pages. The NAC and/or mobile application on the user's mobile device may also be able to pull entity-posted messages and/or similar status information from the social networking pages to include as news topics (e.g., the NAC and/or mobile application on the user's mobile device may include the entity's Twitter updates as news in the entity's profile).

For each news source 206, the NAC and/or mobile application on the user's mobile device may send a message to the news source 208 containing at least the search query. The news source may use the received query to run said query on its available database(s) 210 (e.g., to search news articles and/or other representations of news for the terms contained in the search query). If the news source finds any relevant news in its database(s), it may send the query results to the NAC and/or to the mobile application on the user's mobile device for processing 212. The NAC and/or mobile application on the user's mobile device may then create a profile data structure 214 using the results of the query to build a news profile comprising news related to the entity. If there are other news sources to check for more news 216, the NAC and/or mobile application on the user's mobile device may continue to aggregate data and update the entity news profile.

Once the NAC and/or mobile application on the user's mobile device has searched all available news sources for news pertaining to the entity, it may send a list of news stories associated with the entity profile to the user 218 for display on the user's electronic device. The user may receive the list of news stories associated with the entity profile for review 220 and may use it to read news relating to the entity, and/or to add topics to the profile to further enhance the profile. The user may be able to interact with the profile page.

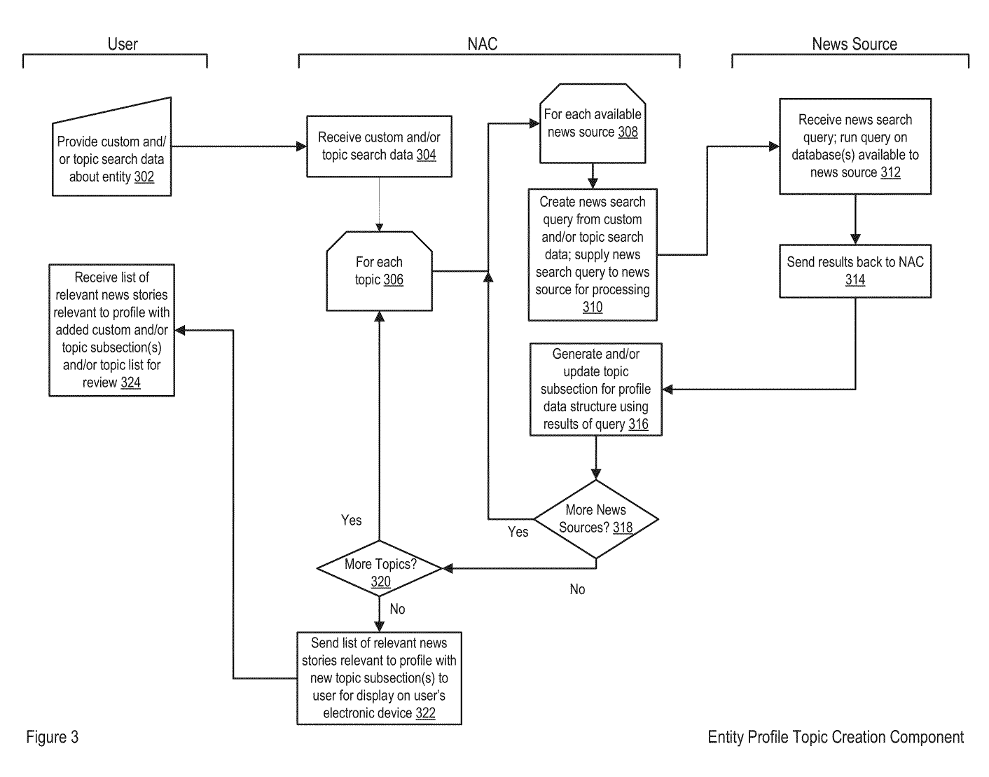

FIG. 3 illustrates a logic flow diagram illustrating creating a topic for an entity profile, according to one embodiment of the present invention. For example, the user may provide topic search data 302 about the entity (e.g., the entity's favorite sports team, favorite celebrities, favorite companies, employer, schools, interests) to the NAC and/or to the mobile application on the user's mobile device. In some implementations topics may be sub-categories within an entity profile which may enhance the profile by aggregating information related to the entity's interests but not directly related to the entity itself. The user may use NAC-suggested and/or the mobile application-suggested topics (e.g., schools, employers) and/or may add a plurality of custom topics based on the user's knowledge of the particular entity and of topics related to the entity. In some implementations, the user may also be able to access LinkedIn or Facebook through the topic interface, allowing the user to provide the entity's social network page or profile such that the NAC and/or mobile application on the user's mobile device may scan and/or otherwise use the content on the social network page or profile to determine topics to automatically generate for the entity, without a user needing to enter topics manually.

Once the NAC and/or mobile application on the user's mobile device receives the topic search data 304, for each topic 306, the NAC may determine a set of news sources (e.g. news websites, news aggregators, search engines) it can poll for news information.

For each news source 308, the NAC and/or mobile application on the user's mobile device may create news search queries based on the topic search data 310. Each topic may generate its own search query based on the topic term(s) provided (e.g., topics “Harvard University,” “Microsoft,” and “computers” may generate search queries “‘Harvard University’”, “Microsoft,” and “computers,” respectively). The NAC and/or mobile application on the user's mobile device may then send a message to the news source containing at least a search query for the topic being searched. The news source may use the received query to run said query on its available database(s) 312 (e.g., to search news articles and/or other representations of news for the topic terms contained in the search query). If the news source finds any relevant news in its database(s) about the topic, it may send the query results to the NAC and/or to the mobile application on the user's mobile device for processing 314. The NAC may then update a profile data structure for the entity via adding and/or updating a topic subsection related to the searched topic, the topic subsection containing the search results of the news query and/or any other news aggregated previously for the topic. If there are other news sources to check for more news 318, the NAC and/or mobile application on the user's mobile device may continue to aggregate data and update the entity news profile.

Once the NAC and/or mobile application on the user's mobile device has searched all available news sources for news pertaining to the topic, it may determine if there are other topics to perform searches for 320. If so, the NAC and/or mobile application on the user's mobile device may continue to generate topic search queries, to provide said search queries to the news sources available, and to update the entity profile with the topic data. The NAC and/or mobile application on the user's mobile device may, after all topics have been added to and/or updated in the entity profile, send a list of news stories associated with the entity profile to the user 322 for display on the user's electronic device. In some implementations, the NAC and/or mobile application on the user's mobile device may include the topics as a sub-section of the entity profile; in other implementations, the NAC and/or mobile application on the user's mobile device may include the topics as separate page(s) associated with the entity profile via a topics list. The user may receive the list of news stories associated with the profile with added news stories sub-sections for the topics and/or topics list for review 324 and may use it to read the retrieved news relating to the entity topics.

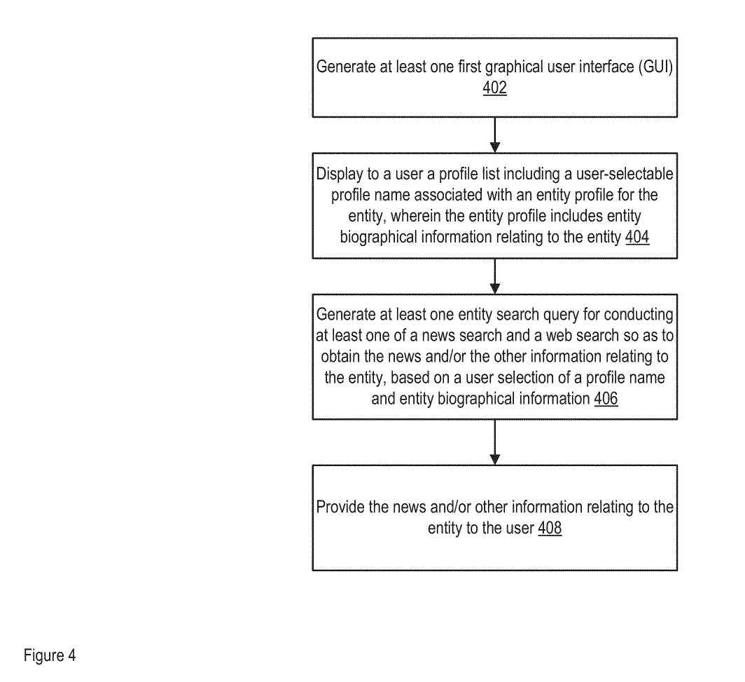

FIG. 4 illustrates a block diagram for creating an entity profile, according to one embodiment of the present invention. In some implementations, a graphical user interface (GUI) may be created and rendered 402 on a user's electronic device. The user may be able to view a profile list which may include user-selectable profile names associated with entity news profiles related to particular entities 404. The entity news profiles may comprise entity biographical information relating to the entity. The electronic device may use a user selection of one of the profile names in the profile list, as well as the entity biographical information contained in the profile, to generate at least one entity search query 406. The search query may be used in order to conduct at least a news search and/or a web search on the entity, in order to obtain news and/or other information about the entity. The electronic device may then provide the news and/or other information related to the entity to the user via an entity profile GUI.

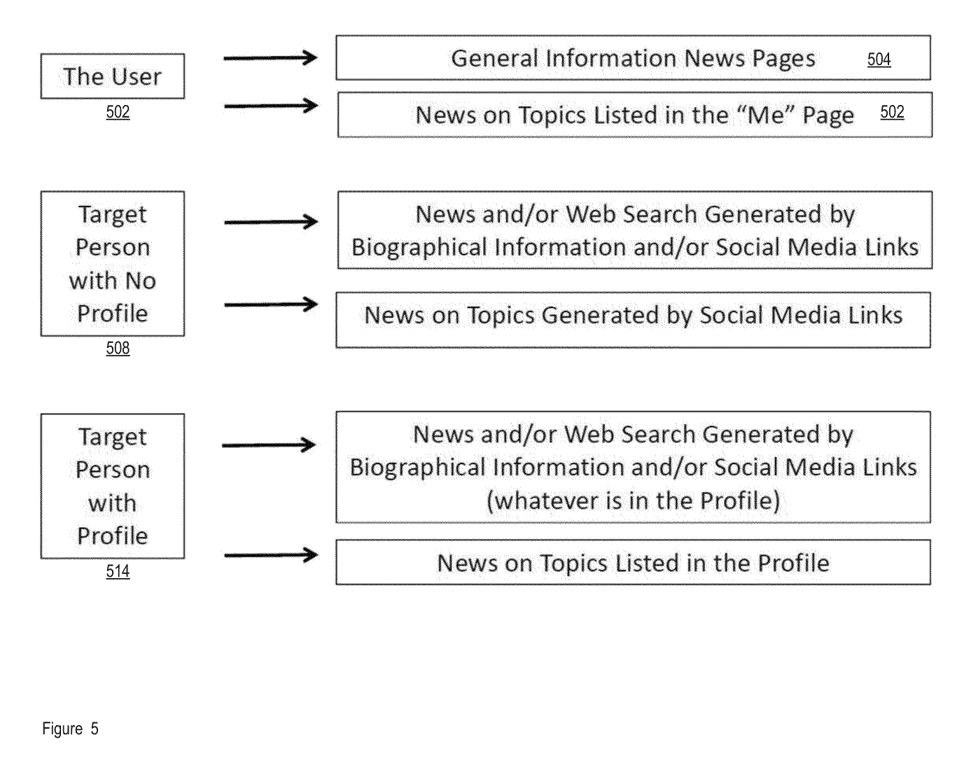

FIG. 5 illustrates a diagram showing how content may be viewed, according to one embodiment of the present invention. The user 502 may, for example, be able to generate a personal profile page for content interesting to the user, which may comprise general information news pages 504 containing general news fitting the user's interests, and may also comprise news content on topics specified by the user on her personal profile 506. Without making a profile for a target entity 508, the user may be able to view news and/or web search content 510 obtained using biographical search data and/or social media data relating to the target, and may also be able to search and view news content relating to topics 512, e.g., based on the target's social media data. Using the profile model for obtaining news for the target 514, the user may persistently be able to view news content on the entity retrieved based on the data aggregated to form the profile 516 and based on any topics specified by the user for the profile 518.

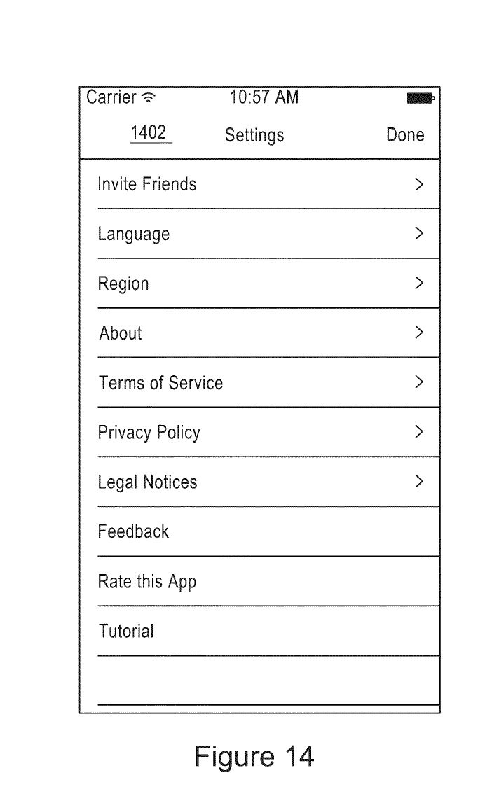

Referring to FIG. 14, the user may be able to access and/or edit various settings 1402 in the application. The user may be able to invite friends to the application, read a description about the application, read the Terms of Service or Privacy Policy of the application, provide feedback pertaining to the application, and/or rate the application, e.g., in an application store (e.g., Apple iTunes Store), and/or the like.

News Aggregation Controller

FIG. 18 shows a block diagram illustrating embodiments of a NAC. In this embodiment, the NAC controller 1801 may serve to aggregate, process, store, search, serve, identify, instruct, generate, match, and/or facilitate interactions with a computer through news retrieval technologies, and/or other related data.

Typically, users, which may be people and/or other systems, may engage information technology systems (e.g., computers) to facilitate information processing. In turn, computers employ processors to process information; such processors 1803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the NAC controller 1801 may be connected to and/or communicate with entities such as, but not limited to: one or more users from user input devices 1811; peripheral devices 1812; an optional cryptographic processor device 1828; and/or a communications network 1813.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The NAC controller 1801 may be based on computer systems that may comprise, but are not limited to, components such as: a computer systemization 1802 connected to memory 1829.

Computer Systemization

A computer systemization 1802 may comprise a clock 1830, central processing unit (“CPU(s)” and/or “processor(s)” (these terms are used interchangeable throughout the disclosure unless noted to the contrary)) 1803, a memory 1829 (e.g., a read only memory (ROM) 1806, a random access memory (RAM) 1805, etc.), and/or an interface bus 1807, and most frequently, although not necessarily, are all interconnected and/or communicating through a system bus 1804 on one or more (mother)board(s) 1802 having conductive and/or otherwise transportive circuit pathways through which instructions (e.g., binary encoded signals) may travel to effectuate communications, operations, storage, etc. The computer systemization may be connected to a power source 1886; e.g., optionally the power source may be internal. Optionally, a cryptographic processor 1826 and/or transceivers (e.g., ICs) 1874 may be connected to the system bus. In another embodiment, the cryptographic processor and/or transceivers may be connected as either internal and/or external peripheral devices 1812 via the interface bus I/O. In turn, the transceivers may be connected to antenna(s) 1875, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing NAC controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the NAC controller and beyond through various interfaces. Should processing requirements dictate a greater amount speed and/or capacity, distributed processors (e.g., Distributed NAC), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the NAC may be achieved by implementing a microcontroller such as CAST's R8051XC2 microcontroller; Intel's MCS 51 (i.e., 8051 microcontroller); and/or the like. Also, to implement certain features of the NAC, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the NAC component collection (distributed or otherwise) and/or features may be implemented via the microprocessor and/or via embedded components; e.g., via ASIC, coprocessor, DSP, FPGA, and/or the like. Alternately, some implementations of the NAC may be implemented with embedded components that are configured and used to achieve a variety of features or signal processing.

Depending on the particular implementation, the embedded components may include software solutions, hardware solutions, and/or some combination of both hardware/software solutions. For example, NAC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the NAC features. A hierarchy of programmable interconnects allow logic blocks to be interconnected as needed by the NAC system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the NAC may be developed on regular FPGAs and then migrated into a fixed version that more resembles ASIC implementations. Alternate or coordinating implementations may migrate NAC controller features to a final ASIC instead of or in addition to FPGAs. Depending on the implementation all of the aforementioned embedded components and microprocessors may be considered the “CPU” and/or “processor” for the NAC.

Power Source

The power source 1886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1886 is connected to at least one of the interconnected subsequent components of the NAC thereby providing an electric current to all subsequent components. In one example, the power source 1886 is connected to the system bus component 1804. In an alternative embodiment, an outside power source 1886 is provided through a connection across the I/O 1808 interface. For example, a USB and/or IEEE 1394 connection carries both data and power across the connection and is therefore a suitable source of power.

Interface Adapters

Interface bus(ses) 1807 may accept, connect, and/or communicate to a number of interface adapters, conventionally although not necessarily in the form of adapter cards, such as but not limited to: input output interfaces (I/O) 1808, storage interfaces 1809, network interfaces 1810, and/or the like. Optionally, cryptographic processor interfaces 1827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1809 may accept, communicate, and/or connect to a number of storage devices such as, but not limited to: storage devices 1814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1810 may accept, communicate, and/or connect to a communications network 1813. Through a communications network 1813, the NAC controller is accessible through remote clients 1833b (e.g., computers with web browsers) by users 1833a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed NAC), architectures may similarly be employed to pool, load balance, and/or otherwise increase the communicative bandwidth required by the NAC controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1810 may be used to engage with various communications network types 1813. For example, multiple network interfaces may be employed to allow for the communication over broadcast, multicast, and/or unicast networks.

Input Output interfaces (I/O) 1808 may accept, communicate, and/or connect to user input devices 1811, peripheral devices 1812, cryptographic processor devices 1828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1811 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1812 may be connected and/or communicate to I/O and/or other facilities of the like such as network interfaces, storage interfaces, directly to the interface bus, system bus, the CPU, and/or the like. Peripheral devices may be external, internal and/or part of the NAC controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the NAC controller may be embodied as an embedded, dedicated, and/or monitor-less (i.e., headless) device, wherein access would be provided over a network interface connection.

Cryptographic units such as, but not limited to, microcontrollers, processors 1826, interfaces 1827, and/or devices 1828 may be attached, and/or communicate with the NAC controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory 1829. However, memory is a fungible technology and resource, thus, any number of memory embodiments may be employed in lieu of or in concert with one another. It is to be understood that the NAC controller and/or a computer systemization may employ various forms of memory 1829. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1829 will include ROM 1806, RAM 1805, and a storage device 1814. A storage device 1814 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory 1829 may contain a collection of program and/or database components and/or data such as, but not limited to: operating system component(s) 1815 (operating system); information server component(s) 1816 (information server); user interface component(s) 1817 (user interface); Web browser component(s) 1818 (Web browser); database(s) 1819; mail server component(s) 1821; mail client component(s) 1822; cryptographic server component(s) 1820 (cryptographic server); the NAC component(s) 1835, including components 1841-1842; and/or the like (i.e., collectively a component collection). These components may be stored and accessed from the storage devices and/or from storage devices accessible through an interface bus. Although non-conventional program components such as those in the component collection, typically, are stored in a local storage device 1814, they may also be loaded and/or stored in memory such as: peripheral devices, RAM, remote storage facilities through a communications network, ROM, various forms of memory, and/or the like.

Operating System

The operating system component 1815 is an executable program component facilitating the operation of the NAC controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the NAC controller to communicate with other entities through a communications network 1813. Various communication protocols may be used by the NAC controller as a subcarrier transport mechanism for interaction, such as, but not limited to: multicast, TCP/IP, UDP, unicast, and/or the like.

Information Server

An information server component 1816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the NAC controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the NAC database 1819, operating systems, other program components, user interfaces, Web browsers, and/or the like.

Access to the NAC database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the NAC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the NAC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 1818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the NAC enabled nodes. The combined application may be nugatory on systems employing standard Web browsers.

Mail Server

A mail server component 1821 is a stored program component that is executed by a CPU 1803. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the NAC.

Access to the NAC mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 1822 is a stored program component that is executed by a CPU 1803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 1820 is a stored program component that is executed by a CPU 1803, cryptographic processor 1826, cryptographic processor interface 1827, cryptographic processor device 1828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the NAC may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the NAC component to engage in secure transactions if so desired. The cryptographic component facilitates the secure accessing of resources on the NAC and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The NAC Database

The NAC database component 1819 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the NAC database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the NAC database is implemented as a data-structure, the use of the NAC database 1819 may be integrated into another component such as the NAC component 1835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1819 includes several tables 1819a-d.

A user account table 1819a includes fields such as, but not limited to: user_ID, user_name, user_password, user_username, user_email, user_location, user_employer, user_school, user_social_networks, user_date_added, and/or the like. The user account table may support and/or track multiple user accounts on a NAC.

A news sources table 1819b includes fields such as, but not limited to: news_ID, news_name, news_address, news_date_added, news_keywords, and/or the like. The news sources table may support and/or track multiple news sources on a NAC.

An entity profiles table 1819c includes fields such as, but not limited to: profile_ID, profile_entity_fname, profile_entity_lname, profile_entity_location, profile_entity_type, profile_entity_employer_latest, profile_entity_employer_prior, profile_entity_school_latest, profile_entity_school_prior, profile_entity_topics, profile_entity_news, profile_entity_date_updated, and/or the like. The entity profiles table may support and/or track multiple entity profile data structures on a NAC.

A profile topics table 1819d includes fields such as, but not limited to: topic_ID, topic_keyword, topic_news, and/or the like. The profile topics table may support and/or track multiple profile topics on a NAC.

In one embodiment, the NAC database may interact with other database systems. For example, employing a distributed database system, queries and data access by search NAC component may treat the combination of the NAC database, an integrated data security layer database as a single database entity.

In one embodiment, user programs may contain various user interface primitives, which may serve to update the NAC. Also, various accounts may require custom database tables depending upon the environments and the types of clients the NAC may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1819a-d. The NAC may be configured to keep track of various settings, inputs, and parameters via database controllers.

The NAC database may communicate to and/or with other components in a component collection, including itself, and/or facilities of the like. Most frequently, the NAC database communicates with the NAC component, other program components, and/or the like. The database may contain, retain, and provide information regarding other nodes and data.

The NACS

The NAC component 1835 is a stored program component that is executed by a CPU. In one embodiment, the NAC component incorporates any and/or all combinations of the aspects of the NAC that was discussed in the previous figures. As such, the NAC affects accessing, obtaining and the provision of information, services, transactions, and/or the like across various communications networks. The features and embodiments of the NAC discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the NAC's features and facilities, and in many cases reduce the costs, energy consumption/requirements, and extend the life of NAC's underlying infrastructure; this has the added benefit of making the NAC more reliable. Similarly, many of the features and mechanisms are designed to be easier for users to use and access, thereby broadening the audience that may enjoy/employ and exploit the feature sets of the NAC; such ease of use also helps to increase the reliability of the NAC. In addition, the feature sets include heightened security as noted via the Cryptographic components 1820, 1826, 1828 and throughout, making access to the features and data more reliable and secure.

The NAC transforms entity information and profile topics 1819d inputs via NAC's Entity Profile Creation 1841 and Entity Profile Topic Creation 1842 components into entity profiles 1819c outputs.

The NAC component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the NAC server employs a cryptographic server to encrypt and decrypt communications. The NAC component may communicate to and/or with other components in a component collection, including itself, and/or facilities of the like. Most frequently, the NAC component communicates with the NAC database, operating systems, other program components, and/or the like. The NAC may contain, communicate, generate, obtain, and/or provide program component, system, user, and/or data communications, requests, and/or responses.

Distributed NACS

The structure and/or operation of any of the NAC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the NAC controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the NAC controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header (′Content-Type: text/plain′);
// set ip address and port to listen to for incoming data
$address = ′192.168.0.100′;
$port = 255;
// create a server-side SSL socket, listen for/accept incoming communication
$sock = socket_create (AF_INET, SOCK_STREAM, 0);
socket_bind ($sock, $address, $port) or die (′Could not bind to address′);
socket_listen ($sock);
$client = socket_accept ($sock);
// read input data from client device in 1024 byte blocks until end of message
do {
$input = ″ ″;
$input = socket_read ($client, 1024);
$data .= $input;
} while ($input != ″ ″);
// parse data to extract variables
$obj = json_decode($data, true);
// store input data in a database
mysql_connect (″201.408.185.132″,$DBserver,$password);
// access database server
mysql_select (″CLIENT_DB.SQL″); // select database to append
mysql_query (″INSERT INTO UserTable (transmission)
VALUES ($data)″); // add data to UserTable table in a CLIENT database
mysql_close (″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/
v2r1/index.jsp?topic=/com.ibm.IBM
DI.doc/referenceguide295.htm

and other parser implementations:

http://publib.boulder.ibm.com/infocenter/tivihelp/
v2r1/index.jsp?topic=/com.ibm.IBM
DI.doc/referenceguide259.htm

all of which are hereby expressly incorporated by reference.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for facilitating access to, and organization of, news and/or other information relating to an entity, the apparatus comprising:
at least one display device;
at least one communication interface;
at least one memory to store processor-executable instructions; and
at least one processor communicatively coupled to the at least one display device, the at least one communication interface, and the at least one memory, wherein upon execution by the at least one processor of the processor-executable instructions, the at least one processor:
A) controls the at least one display device to generate at least one first graphical user interface (GUI) to display to a user a profile list including a user-selectable profile name associated with an entity profile for the entity, wherein the entity profile includes entity biographical information relating to the entity; and
B) in response to a selection by the user of the user-selectable profile name via the at least one first GUI, generates at least one entity search query for conducting at least one of a news search and a web search so as to obtain the news and/or the other information relating to the entity, wherein the at least one entity search query is generated based at least in part on the entity biographical information in the entity profile for the entity.

2. The apparatus of claim 1, wherein:
the entity is a person or a business; and
the entity biographical information includes a name of the person or the business.

3. The apparatus of claim 2, wherein:
the entity is the person; and
the entity biographical information includes the name of the person and at least one of:
a latest employer;
a prior employer;
a latest school;
a prior school; and
a location.

4. The apparatus of claim 3, wherein in B), the at least one processor:
B1) automatically generates the at least one entity search query based on the name of the person and the at least one of the latest employer, the prior employer, the latest school, the prior school, and the location.

5. The apparatus of claim 4, wherein in B1):
if the entity biographical information includes the latest employer, the at least one processor automatically generates the at least one entity search query based on the name of the person and the latest employer;
if the entity biographical information does not include the latest employer but includes the prior employer, the at least one processor automatically generates the at least one entity search query based on the name of the person and the prior employer;
if the entity biographical information does not include the latest employer and the prior employer but includes the latest school, the at least one processor automatically generates the at least one entity search query based on the name of the person and the latest school;
if the entity biographical information does not include the latest employer, the prior employer and the latest school, but includes the prior school, the at least one processor automatically generates the at least one entity search query based on the name of the person and the prior school; and
if the entity biographical information does not include the latest employer, the prior employer, the latest school and the prior school, but includes the location, the at least one processor automatically generates the at least one entity search query based on the name of the person and the location.

6. The apparatus of claim 1, wherein the at least one first GUI includes:
at least one first selectable indicator to allow the user to add a new entity profile to the profile list and/or delete an existing entity profile from the profile list.

7. The apparatus of claim 1, wherein the at least one processor further:
C) generates at least one second computer graphical user interface (GUI) via the at least one display device to facilitate entry by the user of the entity biographical information so as to create or edit the entity profile for the entity.

8. The apparatus of claim 7, wherein in C), the at least one processor:
C1) receives via the at least one second GUI, the entity biographical information entered by the user;
C2) creates the entity profile for the entity, wherein the entity profile includes the entity biographical information; and
C3) stores the entity profile for the entity in the at least one memory.

9. The apparatus of claim 1, wherein the at least one processor further:
D) electronically transmits, via the at least one communication interface, the at least one entity search query to at least one web search engine and/or at least one news aggregator/curator; and
E) electronically receives, via the at least one communication interface, at least one entity search result from the at least one web search engine and/or the at least one news aggregator/curator based on the at least one entity search query, wherein the at least one entity search result constitutes at least some of the news and/or the other information relating to the entity.

10. The apparatus of claim 9, wherein:
in D), the at least one entity search query is electronically transmitted to the at least one web search engine;
in E), the at least one entity search result is electronically received from the at least one web search engine; and
the at least one web search engine includes at least one of:
Google®;
Yahoo!®;
Bing®; and
DuckDuckGo™.

11. The apparatus of claim 9, wherein:
in D), the at least one entity search query is electronically transmitted to the at least one news aggregator/curator;
in E), the at least one entity search result is electronically received from the at least one news aggregator/curator; and
the at least one news aggregator/curator includes at least one of:
Google® News;
Yahoo!® News;
Flipboard®;
Feedly®;
Circa®;
LinkedIn® Pulse;
Breaking News™;
Newsify™;
SNews®;
G-News®;
News & Weather™;
Newsle®;
Newsfeed™;
Bloglovin™;
Kknews™;
Top News™;
Zite®;
Umano™;
Now This News™;
Buzzfeed®;
G!News Free™;
Digg®; and
Newsblur™.

12. The apparatus of claim 9, wherein the at least one processor further:
G) generates at least one third GUI via the at least one display device so as to provide to the user the at least one entity search result, wherein the at least one third GUI includes at least one second selectable indicator to allow the user to add or link the at least one entity search result to the entity profile; and
H) adds or links the at least one entity search result to the entity profile based on activation by the user of the at least one second selectable indicator,
wherein the at least one entity search result includes at least one of:
at least one web page provided by the at least one web search engine; and
at least one news article provided by the at least one news aggregator/curator.

13. The apparatus of claim 12, wherein the at least one processor further:
I) electronically provides, via control of the at least one display device, at least one third selectable indicator to allow the user to access the at least one entity search result after the at least one entity search result is added or linked to the entity profile.

14. The apparatus of claim 13, wherein the at least one processor further:
J) electronically provides, via control of the at least one display device by the at least one processor, at least one fourth selectable indicator to allow the user to select either the news search or the web search to be conducted based on the at least one entity search query.

15. The apparatus of claim 9, wherein the at least one processor further:
generates at least one fourth GUI via the at least one display device so as to display to the user a topic list relating to the entity, wherein the topic list is linked to or included in the entity profile for the entity.

16. The apparatus of claim 15, wherein:
each topic identifier in the topic list displayed by the at least one fourth GUI is a selectable topic identifier to allow the user to initiate a topic news search based on a corresponding topic; and
in response to the user selecting the selectable topic identifier for the corresponding topic in the topic list:
in C), the at least one processor electronically transmits, via the at least one communication interface, the least one entity search query to the at least one news aggregator/curator based at least in part on the corresponding topic; and
in D) the at least one processor electronically receives, via the at least one communication interface, the at least one entity search result from the at least one news aggregator/curator based on the at least one entity search query.

17. A hand-held mobile computing apparatus for facilitating access to, and organization of, news and/or other information relating to an entity or a subject, the apparatus comprising:
at least one display device;
at least one communication interface;
at least one memory to store processor-executable instructions; and
at least one processor communicatively coupled to the at least one display device, the at least one communication interface, and the at least one memory, wherein upon execution by the at least one processor of the processor-executable instructions, the at least one processor:
A) controls the at least one display device to generate at least one first graphical user interface (GUI) to display to a user a profile list including a user-selectable profile name associated with one of an entity profile for the entity and a subject profile for the subject;
B) in response to a selection by the user of the user-selectable profile name via the at least one first GUI, generates at least one search query for conducting at least one of a news search and a web search so as to obtain the news and/or the other information relating to the entity or the subject corresponding to the user-selectable profile name selected in A), wherein the at least one search query is generated based at least in part on contents in the entity profile for the entity or the subject profile for the subject corresponding to the user-selectable profile name selected in A);
C) controls the at least one display device to generate at least one second graphical user interface (GUI) to display to the user a topic list relating to the entity or the subject, wherein the topic list is linked to or included in the entity profile for the entity or the subject profile for the subject;
D) electronically transmits, via the at least one communication interface, the at least one search query to at least one web search engine and/or at least one news aggregator/curator; and
E) electronically receives, via the at least one communication interface, at least one search result from the at least one web search engine and/or the at least one news aggregator/curator based on the at least one search query, wherein the at least one search result constitutes at least some of the news and/or the other information relating to the entity or the subject.

18. The apparatus of claim 17, wherein:
in C), each topic identifier in the topic list displayed by the at least one second GUI is a selectable topic identifier to allow the user to initiate a topic news search based on a corresponding topic; and
in response to the user selecting the selectable topic identifier for the corresponding topic in the topic list:
in D), the at least one processor electronically transmits, via the at least one communication interface, the least one search query to the at least one news aggregator/curator based at least in part on the corresponding topic; and
in E) the at least one processor electronically receives, via the at least one communication interface, the at least one search result from the at least one news aggregator/curator based on the at least one search query.

19. The apparatus of claim 18, wherein the at least one processor further:
F) generates at least one third GUI via the at least one display device so as to provide to the user the at least one search result, wherein the at least one third GUI includes at least one second selectable indicator to allow the user to add or link the at least one search result to the entity profile or the subject profile; and
G) adds or links the at least one search result to the entity profile or the subject profile based on activation by the user of the at least one second selectable indicator,
wherein the at least one search result includes at least one of:
at least one web page provided by the at least one web search engine; and
at least one news article provided by the at least one news aggregator/curator.

20. A computer-implemented method of aggregating news, the method comprising:
A) electronically receiving from a user at least one biographical term and at least one topic term relating to an entity;
B) electronically generating an entity news profile using the at least one biographical term and the at least one topic term;
C) electronically generating a first search query using the at least one biographical term in the entity news profile;
D) electronically generating at least a second search query using the at least one topic term in the entity news profile;
E) electronically sending the first search query and the at least a second search query to a news source database;
F) electronically receiving from the news source database a first set of news results related to the first search query, and at least a second set of news results related to the at least second search query;
G) electronically instantiating an entity profile page based on the at least one biographical term and the first set of results;
H) electronically generating at least one topic page using the at least second set of news results;
I) electronically incorporating the at least one topic page in the entity profile page; and
J) electronically presenting the entity profile page to the user via a graphical user interface viewable on an electronic device.
